(19) United States
(12) Patent Application Publication
(10) Pub. No.: US 2017/0194010 A1
(43) Pub. Date: Jul. 6, 2017

(54) METHOD AND APPARATUS FOR IDENTIFYING CONTENT AND AUDIO SIGNAL PROCESSING METHOD AND APPARATUS FOR IDENTIFYING CONTENT

(71) Applicant: Electronics and Telecommunications Research Institute, Daejeon (KR)

(72) Inventors: Jong Mo SUNG, Daejeon (KR); Tae Jin PARK, Daejeon (KR); Seung Kwon BEACK, Daejeon (KR); Tae Jin LEE, Daejeon (KR); Jin Soo CHOI, Daejeon (KR)

(73) Assignee: Electronics and Telecommunications Research Institute, Daejeon (KR)

(21) Appl. No.: 15/388,408

(22) Filed: Dec. 22, 2016

(30) Foreign Application Priority Data
Dec. 31, 2015 (KR) 10-2015-0191165

(51) Int. Cl. G10L 19/018; G06F 17/30; G10L 19/02

(52) U.S. Cl. CPC G10L 19/018; G10L 19/0204; G06F 17/30743

(57) ABSTRACT

Disclosed are a content identifying method and apparatus, and an audio signal processing apparatus and method for identifying content. The audio signal processing method for registration includes splitting an original audio signal into a lower band signal and a higher band signal; modifying the higher band signal using an metadata associated to the original audio signal; storing a reference lower band fingerprint extracted from the lower band signal, a reference higher band fingerprint extracted from the modified higher band signal, and the associated metadata in database; and generating a reference audio signal synthesized using the lower band signal and the modified higher band signal.

### CROSS-REFERENCE TO RELATED APPLICATION(S)

This application claims the priority benefit of Korean Patent Application No. 10-2015-0191165 filed on Dec. 31, 2015, in the Korean Intellectual Property Office, the disclosure of which is incorporated herein by reference for all purposes.

### BACKGROUND

1. Field

One or more example embodiments relate to a content identification method and apparatus, and an audio signal processing apparatus and method for identifying content.

2. Description of Related Art

Currently, with the spread of various smart devices and high-speed Internet, there is a sudden increase in the distribution of digital contents beyond a conventional content distribution method through broadcasting, optical media, and the like. To protect the right of a copyright holder and to improve the user convenience using contents in the distribution of contents, content being distributed is to be identified at high accuracy.

One of representative content identification technologies, for example, audio fingerprinting technology may associate a fingerprint corresponding to a unique characteristic extracted from an audio signal with corresponding audio metadata. At a registration stage of the audio fingerprinting technology, a reference fingerprint extracted from an audio signal may be converted to a hash code, and the hash code may be stored in a database together with its associated metadata. At a search stage, a search fingerprint may be extracted from an audio signal received at a user terminal, and metadata corresponding to a reference fingerprint that matches the search fingerprint may be output.

### SUMMARY

At least one example embodiment provides a method and apparatus that may maintain the compatibility with an existing audio fingerprint by identifying content based on a hierarchical audio fingerprint and may identify a various versions of content, which may cannot be identified through an existing audio fingerprint.

At least one example embodiment also provides a method and apparatus that may minimize a degradation in the quality of an audio signal and may shorten a processing delay due to silence intervals contained in the audio contents by modifying a higher band signal relatively less perceptible to human hearing and extracting a higher band fingerprint from the higher band signal.

According to at least one example embodiment, there is provided a method of processing an audio signal for registration, the method including splitting an original audio signal into a lower band signal and a higher band signal; modifying the higher band signal using an metadata associated to the original audio signal; storing a reference lower band fingerprint extracted from the lower band signal, a reference higher band fingerprint extracted from the modified higher band signal, and the associated metadata in database; and generating a reference audio signal synthesized using the lower band signal and the modified higher band signal.

The modifying of the higher band signal may comprise transforming the higher band signal to a higher band spectrum; spectrally modifying the higher band spectrum to generate the modified higher band spectrum using the content ID (identifier) from metadata or arbitrary ID; inverse-transforming the modified higher band spectrum to the modified higher band signal.

The spectrally modifying the higher band spectrum may comprise generating a random spectrum using the content ID or the arbitrary ID as a seed for random number generator; decomposing the higher band spectrum into magnitude spectrum and phase spectrum; adding the random spectrum to the magnitude spectrum of the higher band spectrum to generate the modified magnitude spectrum; combining the modified magnitude spectrum and the phase spectrum to generate the modified higher band spectrum.

The random spectrum may correspond to an inaudible band of a human that is determined based on an auditory perception characteristic of the human.

The reference lower band fingerprint may include information capable of identifying content included in the reference audio signal.

The reference higher band fingerprint may include information capable of identifying content included in the reference audio signal and a version of the content.

The database may store metadata of content included in an original audio signal and a reference lower band fingerprint and a reference higher band fingerprint extracted from the original audio signal.

The reference higher band fingerprint may be determined by modifying the higher band signal split from the original audio signal and by using a unique characteristic extracted from the modified higher band signal.

According to at least one example embodiment, there is provided a method of identifying content, the method including splitting a unknown reference audio signal into a lower band signal and a higher band signal; extracting a lower band fingerprint from the lower band signal; extracting a higher band fingerprint from the higher band signal; searching reference lower band fingerprint in database using the lower band fingerprint as query to determine candidate set of reference higher band fingerprint and corresponding metadata set; and searching reference higher band fingerprint in the candidate set using the higher band fingerprint as a query to determine a metadata for the matched reference higher band fingerprint.

According to at least one example embodiment, there is provided an audio signal processing apparatus for registration including a memory; and a processor configured to execute instructions stored on the memory. The processor is configured to split an original audio signal into a lower band signal and a higher band signal; modify the higher band signal using an metadata associated to the original audio signal; store a reference lower band fingerprint extracted from the lower band signal, a reference higher band fingerprint extracted from the modified higher band signal, and the associated metadata in database; and generate a reference audio signal synthesized using the lower band signal and the modified higher band signal.

The processor may be further configured to transforming the higher band signal to a higher band spectrum; spectrally modifying the higher band spectrum to generate the modified higher band spectrum using the content ID from metadata or arbitrary ID; inverse-transforming the modified higher band spectrum to the modified higher band signal.

The processor may be further configured to generating a random spectrum using the content ID or the arbitrary ID as a seed for random number generator; decomposing the higher band spectrum into magnitude spectrum and phase spectrum; adding the random spectrum to the magnitude spectrum of the higher band spectrum to generate the modified magnitude spectrum; combining the modified magnitude spectrum and the phase spectrum to generate the modified higher band spectrum.

The random spectrum may correspond to an inaudible band of a human that is determined based on an auditory perception characteristic of the human.

The reference lower band fingerprint may include information capable of identifying content included in the reference audio signal.

The reference higher band fingerprint may include unique information capable of identifying content included in the reference audio signal.

According to example embodiments, it is possible to maintain the compatibility with an existing audio fingerprint by identifying content based on a hierarchical audio fingerprint, and to identify a various versions of content, which cannot be identified through an existing audio fingerprint.

Also, according to example embodiments, it is possible to minimize a degradation in the quality of an audio signal and may shorten a processing delay due to silence intervals contained in the audio contents by modifying a higher band signal relatively less perceptible to human hearing and extracting a higher band fingerprint from the higher band signal.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a relationship between an audio signal processing apparatus and a content identifying apparatus according to an example embodiment;

FIG. 2 is a diagram illustrating an operation of an audio signal processing apparatus according to an example embodiment;

FIG. 3 is a diagram illustrating an operation of a band splitter according to an example embodiment;

FIG. 4 is a diagram illustrating an operation of a higher band signal modifier according to an example embodiment;

FIG. 5 is a diagram illustrating an operation of a spectrum modifier according to an example embodiment;

FIG. 6 illustrates a process of modifying a higher band spectrum according to an example embodiment;

FIG. 7 is a diagram illustrating an operation of a band synthesizer according to an example embodiment;

FIG. 8 is a diagram illustrating an operation of a content identifying apparatus according to an example embodiment;

FIG. 9 is a flowchart illustrating an audio signal processing method according to an example embodiment;

FIG. 10 is a flowchart illustrating a content identifying method according to an example embodiment;

FIG. 11 is a block diagram illustrating an audio signal processing apparatus according to an example embodiment; and

FIG. 12 is a block diagram illustrating a content identifying apparatus according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

The following example embodiments may be applied to identify content included in an audio signal based on a fingerprint extracted from an audio signal. To identify the content included in the audio signal based on the fingerprint extracted from the audio signal, a predetermined (or, alternatively, desired) operation is to be performed in advance. An operation of storing the fingerprint extracted from the audio signal in a database together with metadata corresponding to the content included in the audio signal may need to be performed in advance. The content included in the audio signal may be identified through an operation of extracting the fingerprint from the audio signal that includes the content to be identified and searching the database for metadata by using the extracted fingerprint as a query.

Example embodiments may be configured as various types of products, for example, a personal computer (PC), a laptop computer, a tablet computer, a smartphone, a television (TV), a smart electronic device, a smart vehicle, a wearable device, and the like. The example embodiments may be applicable to identify content included in an audio signal, which is reproduced at a smartphone, a mobile device, a smart home system, and the like. Hereinafter, example embodiments will be described with reference to the accompanying drawings. Like reference numerals refer to like elements.

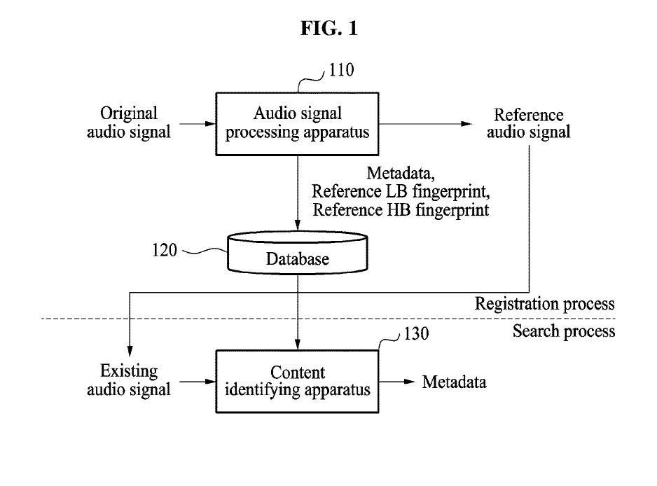

FIG. 1 is a diagram illustrating a relationship between an audio signal processing apparatus and a content identifying apparatus according to an example embodiment.

Audio fingerprint technology refers to technology for identifying content included in an audio signal by relating a unique characteristic extracted from an audio signal to metadata of the content included in the audio signal. The audio fingerprint technology includes a registration process of storing, in a database, a reference fingerprint extracted from an input audio signal and metadata of content included in the audio signal and a search process of extracting a search fingerprint from an audio signal including the content to be identified and searching the database for metadata of the content to be identified by using the extracted search fingerprint as a query.

FIG. 1 illustrates an audio signal processing apparatus 110 configured to perform a registration process, a database 120 configured to store metadata and a reference fingerprint, and a content identifying apparatus 130 configured to perform the search process.

The audio signal processing apparatus 110 may receive an original audio signal. The audio signal processing apparatus 110 may split the original audio signal into a lower band (LB) signal and a higher band (HB) signal. The audio signal processing apparatus 110 may extract a reference LB fingerprint from the LB signal. The audio signal processing apparatus 110 may modify the HB signal signal using an metadata associated to the original audio signal and may extract a reference HB fingerprint from the modified HB signal. The audio signal processing apparatus 110 may store metadata of content included in the original audio signal, the reference LB fingerprint, and the reference HB fingerprint in the database 120 as a single set. The audio signal processing apparatus 110 may generate a reference audio signal synthesized using the LB signal and the modified HB signal. The reference audio signal generated at the audio signal processing apparatus 110 may be distributed to the content identifying apparatus 130 through a variety of paths, such as a wired/wireless network and the like.

The content identifying apparatus 130 may receive the reference audio signal. Here, the reference audio signal may be an audio signal generated at the audio signal processing apparatus 110. The content identifying apparatus 130 may split the reference audio signal into an LB signal and an HB signal. The content identifying apparatus 130 may extract a search LB fingerprint from the LB signal and may extract a search HB fingerprint from the HB signal. The content identifying apparatus 130 may search the database 120 for metadata of content included in the reference audio signal by using the search LB fingerprint as a query. The content identifying apparatus 130 may search for metadata of content included in the reference audio signal by determining a reference LB fingerprint that matches the search LB fingerprint among reference LB fingerprints stored in the database 120. When a plurality of sets of metadata are retrieved through the search LB fingerprint, the content identifying apparatus 130 may search for metadata corresponding to content included in the reference audio signal and a content version by using the search HB fingerprint as a query. The content identifying apparatus 130 may search for metadata corresponding to content included in the reference audio signal and a content version by determining a reference HB fingerprint that matches the search HB fingerprint among reference HB fingerprints of the plurality of sets of metadata.

A reference LB fingerprint may be used to identify content included in a reference audio signal, and may include unique information capable of identifying the content. A reference HB fingerprint may be used to identify the content included in the reference audio signal and a version of the content, and may include unique information capable of identifying the content and the version of the content.

In detail, content included in a reference audio signal and a version of the content may be identified using a reference HB fingerprint. The version of the content may indicate whether the content is an original or a copy among contents that include the same music. Also, the version of the content may include information capable of distinguishing different moving picture contents that include the same music. For example, different advertising contents in which the same background music is used may not be readily distinguished based on a reference LB fingerprint, however, may be distinguished based on a reference HB fingerprint.

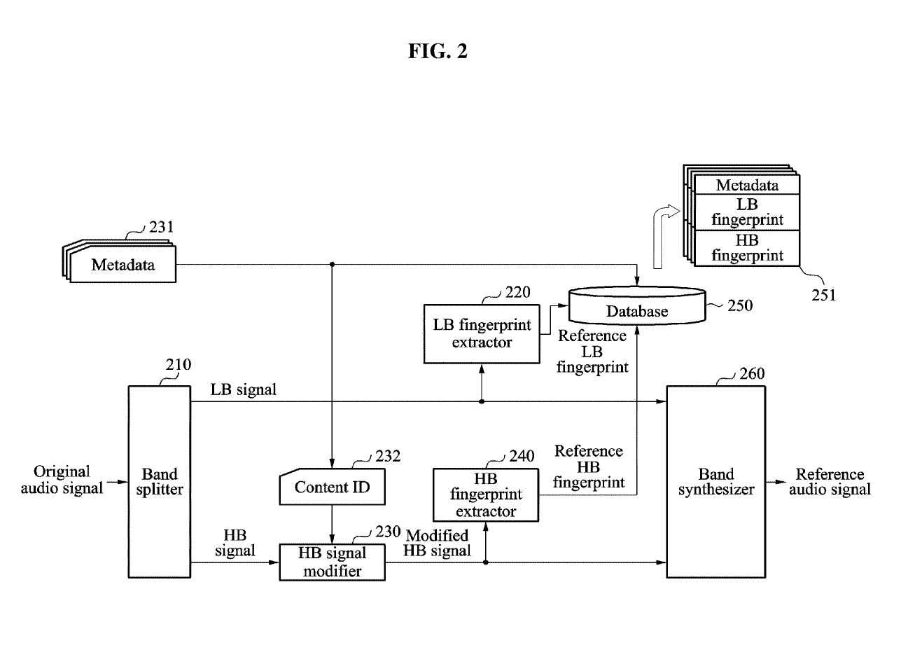

FIG. 2 is a diagram illustrating an operation of an audio signal processing apparatus according to an example embodiment.

Referring to FIG. 2, the audio signal processing apparatus may include a band splitter 210, an LB fingerprint extractor 220, an HB signal modifier 230, an HB fingerprint extractor 240, and a band synthesizer 260. Depending on example embodiments, a database 250 may be embedded in the audio signal processing apparatus, or may be provided outside the audio signal processing apparatus and connected to the audio signal processing apparatus over a wired/wireless network.

Constituent elements of the audio signal processing apparatus of FIG. 2 may be configured as a single processor or a multi-processor. Alternatively, the constituent elements of the audio signal processing apparatus may be configured as a plurality of modules included in different apparatuses. In this case, the plurality of modules may be connected to each other over a network and the like. The audio signal processing apparatus may be installed in various computing devices and/or systems, for example, a smartphone, a mobile device, a wearable device, a personal computer (PC), a laptop computer, a tablet computer, a smart vehicle, a television (TV), a smart electronic device, an autonomous vehicle, a robot, and the like.

The band splitter 210 may split a received original audio signal into an LB signal and an HB signal based on a preset cutoff frequency.

The LB fingerprint extractor 220 may determine a reference LB fingerprint by extracting a unique characteristic included in the LB signal.

The HB signal modifier 230 may modify the HB signal based on an arbitrary identifier (ID) or metadata 231 of content included in the original audio signal. For example, the HB signal modifier 230 may modify the HB signal so that a unique characteristic included in the HB signal may be altered based on the arbitrary ID or a content ID 232 included in the metadata 231.

The HB fingerprint extractor 240 may determine a reference HB fingerprint by extracting a unique characteristic included in the modified HB signal.

The database 250 may store the metadata 231, the reference LB fingerprint, and the reference HB fingerprint. For example, the database 250 may store the metadata 231, the reference LB fingerprint, and the reference HB fingerprint corresponding to the content included in the same original audio signal in a data table 251 corresponding to the content as a single set.

The band synthesizer 260 may generate a reference audio signal that includes the LB signal and the modified HB signal.

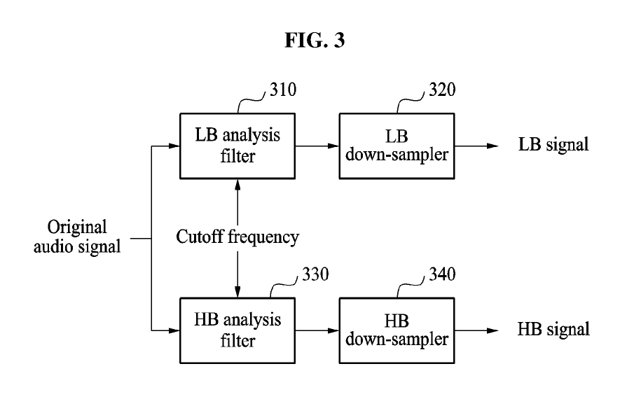

FIG. 3 is a diagram illustrating an operation of a band splitter according to an example embodiment.

Referring to FIG. 3, the band splitter may include an LB analysis filter 310, an LB down-sampler 320, an HB analysis filter 330, and an HB down-sampler 340.

The LB analysis filter 310 may determine a lower band pass (LBP) filter signal from an original audio signal based on a cutoff frequency. The LB analysis filter 310 may determine the LBP filter signal that includes a frequency component of less than the cutoff frequency in the original audio signal. The LB analysis filter 310 may include, for example, a quadrature mirror filter (QMF) and the like as a filter designed to perform a full recovery.

The LB down-sampler 320 may output an LB signal by changing a sampling frequency of the LBP filter signal.

The HB analysis filter 330 may determine a higher band pass (HBP) filter signal from the original audio signal based on the cutoff frequency. The HB analysis filter 330 may determine the HBP filter signal that includes a frequency component of the cutoff frequency or more in the original audio signal. The HB analysis filter 330 may include, for example, a QMF and the like as a filter designed to perform a full recovery.

The HB down-sampler 340 may output an HB signal by changing a sampling frequency of the HBP filter signal.

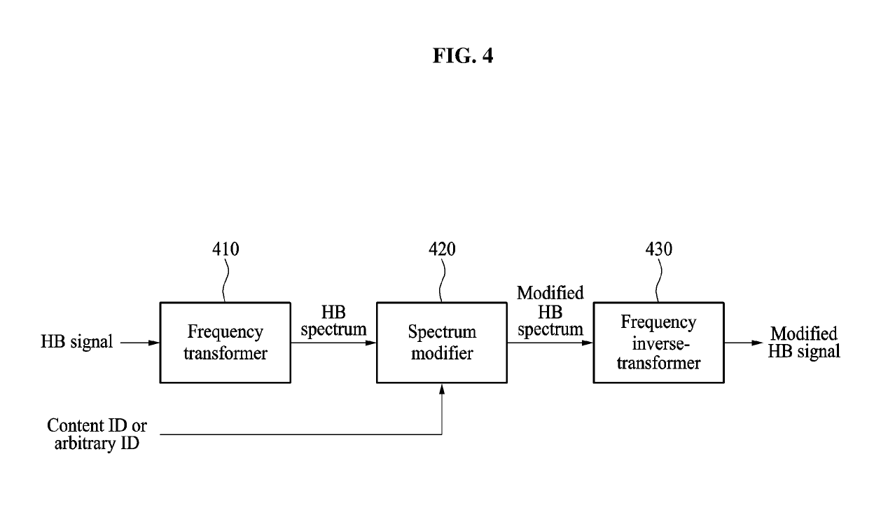

FIG. 4 is a diagram illustrating an operation of an HB signal modifier according to an example embodiment.

Referring to FIG. 4, the HB signal modifier may include a frequency transformer 410, a spectrum modifier 420, and a frequency inverse-transformer 430.

The frequency transformer 410 may transform an HB signal of a time domain to an HB spectrum of a frequency domain. For example, to transform the HB signal of the time domain to the HB spectrum of the frequency domain, the frequency transformer 410 may employ a fast Fourier transform (FFT), a modified discrete cosine transform (MDCT), and the like.

The spectrum modifier 420 may modify the HB spectrum using the content ID from metadata or arbitrary ID. Here, the metadata indicates metadata of content included in an original audio signal, and may include, for example, a content ID included in the metadata. The spectrum modifier 420 may modify the HB spectrum using the content ID. The spectrum modifier 420 may modify a portion corresponding to a preset band in the HB spectrum.

The preset band may be an inaudible band of a human that is determined based on an auditory perception characteristic of the human. Since the portion corresponding to the preset band in the HB spectrum is modified, it is possible to prevent a degradation in the quality of the audio signal occurring due to a modification without an awareness of a user about a modification of the HB spectrum or the HB signal.

The frequency inverse-transformer 430 may inversely transform the modified HB spectrum of the frequency domain to the time domain and thereby output the modified HB signal. For example, the frequency inverse-transformer 430 may employ an inverse FFT (IFFT), an inverse MDCT (IMDCT), and the like, to transform the modified HB spectrum of the frequency domain to the modified HB signal of the time domain.

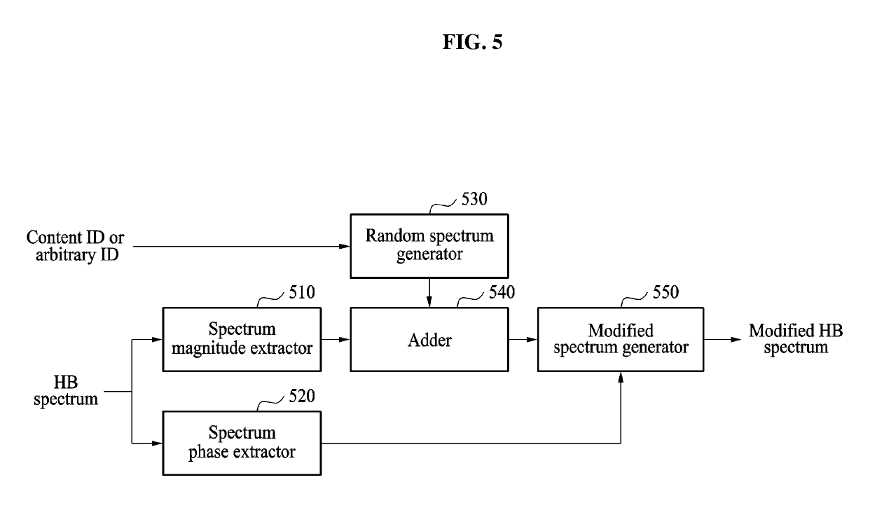

FIG. 5 is a diagram illustrating an operation of a spectrum modifier according to an example embodiment.

Referring to FIG. 5, the spectrum modifier may include a spectrum magnitude extractor 510, a spectrum phase extractor 520, a random spectrum generator 530, an adder 540, and a modified spectrum generator 550.

The spectrum magnitude extractor 510 may extract a magnitude component of an HB spectrum. For example, the magnitude component of the HB spectrum may be extracted according to Equation 1.

|S_{HB}(k)|={square root over ({Re(S_{HB}(k))}²+{Im(S_{HB}(k))}²)},

k=kₛ, . . . , kₑ [Equation 1]

In Equation 1, S_{HB}(k) denotes a coefficient of the HB spectrum transformed to the) frequency domain, Re(·) denotes a real number portion of a complex number, Im(·) denotes an imaginary number portion of the complex number, kₛ denotes a start index of a preset band to be modified, and kₑ denotes an end index of the preset band to be modified. The preset band may correspond to an inaudible band of a human that is determined based on an auditory perception characteristic of the human to minimize a degradation in the quality of an audio signal occurring due to a modification.

The spectrum phase extractor 520 may extract a phase component of the HB spectrum. For example, the phase component of the HB spectrum may be extracted according to Equation 2.

$$∅ ( {S}_{HB} ( k ) ) = {tan}^{- 1} ( \frac{Im ( {S}_{HB} ( k ) )}{Re ( {S}_{HB} ( k ) )} ) \\ k = {k}_{s} , … , {k}_{e} \qquad [ Equation 2 ]$$

The random spectrum generator 530 may generate a random spectrum with respect to the preset band based on a content ID of metadata or an arbitrary ID. For example, the random spectrum generator 530 may generate a random spectrum by scaling a random number generated by applying the content ID of metadata or the arbitrary ID as a seed, based on a predetermined gain. The generated random spectrum may include a magnitude component excluding the phase component.

The adder 540 may modify the magnitude component of the HB spectrum based on the random spectrum. For example, the adder 540 may determine the modified magnitude component of the HB spectrum by adding the random spectrum and the magnitude component of the HB spectrum. The adder 540 may add the random spectrum and the magnitude component of the HB spectrum according to Equation 3.

$$\vert {S}_{HB}^{′} ( k ) \vert = \{ \begin{matrix}\vert {S}_{HB} ( k ) \vert + {E}_{HB} ( k ) , & if \vert {S}_{HB} ( k ) \vert + {E}_{HB} ( k ) > 0 \\ 0 & otherwise\end{matrix} \\ k = {k}_{s} , … , {k}_{e} \qquad [ Equation 3 ]$$

In Equation 3, E_{HB}(k) denotes the random spectrum and |S′_{HB}(k)| denotes the magnitude component of the HB spectrum.

The modified spectrum generator 550 may determine a modified HB spectrum based on the modified magnitude component and the phase component of the HB spectrum. The modified spectrum generator 550 may generate the modified HB spectrum based on the modified magnitude component and the phase component of the HB spectrum according to Equation 4.

S′_{HB}(k)=|S′_{HB}(k)| cos {φ(S_{HB}(k))}+j|S′_{HB}(k)| sin {φ(S_{HB}(k))}

k=kₛ, . . . , kₑ [Equation 4]

In Equation 4, S′_{HB}(k) denotes the modified HB spectrum and j denotes \sqrt{−1}.

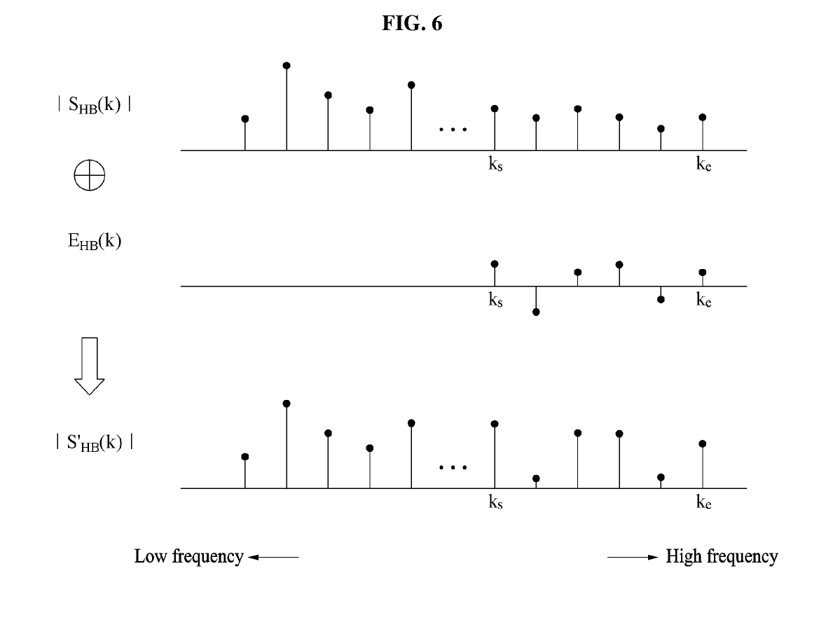

FIG. 6 illustrates a process of modifying an HB spectrum according to an example embodiment.

Referring to FIG. 6, a top graph shows an example of a magnitude component of an HB spectrum, a middle graph shows an example of a random spectrum, and a bottom graph shows an example of a modified magnitude component of an HB spectrum.

The modified magnitude component of the HB spectrum may be determined by modifying the magnitude component of the HB spectrum based on the random spectrum. For example, the modified magnitude component of the HB spectrum may be determined by adding the magnitude component of the HB spectrum and the random spectrum.

Here, the random spectrum may have a meaningful spectrum coefficient in a preset band. Here, the HB spectrum may be modified with respect to a preset band corresponding to an inaudible band of a human.

Referring to the bottom graph, a spectrum coefficient between kₛ corresponding to a start index of the preset band and kₑ corresponding to an end index of the preset band in the HB spectrum may be modified.

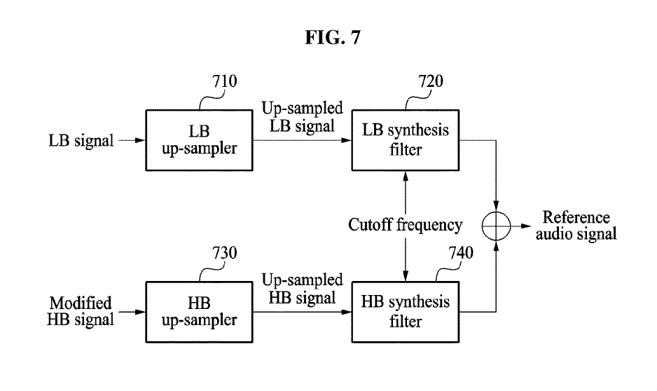

FIG. 7 is a diagram illustrating an operation of a band synthesizer according to an example embodiment.

Referring to FIG. 7, the band synthesizer may include an LB up-sampler 710, an LB synthesis filter 720, an HB up-sampler 730, and an HB synthesis filter 740.

The LB up-sampler 710 may output an up-sampled LB signal by changing a sampling frequency of an LB signal to be equal to a sampling frequency of an original audio signal.

The LB synthesis filter 720 may remove an aliasing component of the up-sampled LB signal. For example, the LB synthesis filter 720 may remove the aliasing component based on a cutoff frequency.

The HB up-sampler 730 may output an up-sampled HB signal by changing a sampling frequency of a modified HB signal to be equal to the sampling frequency of the original audio signal.

The HB synthesis filter 740 may remove an aliasing component of the up-sampled HB signal. For example, the HB synthesis filter 740 may remove the aliasing component based on the cutoff frequency.

The LB signal and the HB signal each in which the aliasing component is removed may be added up and constitute a reference audio signal. The reference audio signal may be generated to include the LB signal and the HB signal each in which the aliasing component is removed.

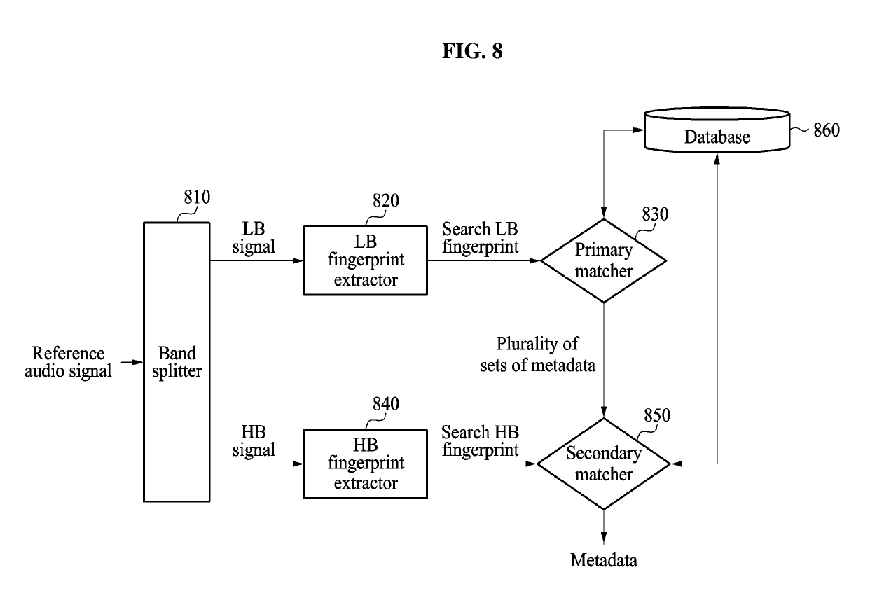

FIG. 8 is a diagram illustrating an operation of a content identifying apparatus according to an example embodiment.

Referring to FIG. 8, the content identifying apparatus may include a band splitter 810, an LB fingerprint extractor 820, a primary matcher 830, an HB fingerprint extractor 840, and a secondary matcher 850. Depending on example embodiments, a database 860 may be embedded in the content identifying apparatus, or may be provided outside the content identifying apparatus and connected to the content identifying apparatus over a wired/wireless network.

Constituent elements of the content identifying apparatus of FIG. 8 may be configured as a single processor or a multi-processor. Alternatively, the constituent elements of the content identifying apparatus may be configured as a plurality of modules included in different apparatuses. In this case, the plurality of modules may be connected to each other over a network and the like. The content identifying apparatus may be installed in various communication apparatuses and/or systems, for example, a smartphone, a mobile device, a wearable device, a PC, a laptop computer, a tablet computer, a smart vehicle, a TV, a smart electronic device, an autonomous vehicle, a robot, and the like.

The band splitter 810 may split a received reference audio signal into an LB signal and an HB signal based on a preset cutoff frequency.

The LB fingerprint extractor 820 may determine a search LB fingerprint by extracting a unique characteristic included in the LB signal. That is, the LB fingerprint extractor 820 may extract the search LB fingerprint from the LB signal based on the unique characteristic included in the LB signal.

The primary matcher 830 may determine metadata corresponding to content included in the reference audio signal based on the search LB fingerprint. The primary matcher 830 may search for metadata corresponding to the search LB fingerprint from among a plurality of sets of metadata stored in the database 860 by using the search LB fingerprint as a query. For example, the primary matcher 830 may determine a reference LB fingerprint having a similarity greater than a preset reference value with the search LB fingerprint among reference LB fingerprints stored in the database 860, and may determine metadata corresponding to the determined LB fingerprint as a search result.

If a single set of metadata is determined at the primary matcher 830, the content identifying apparatus may output the determined metadata as information about the content.

If a plurality of sets of metadata are determined at the primary matcher 830, the content identifying apparatus may additionally perform a metadata search using a search HB fingerprint.

The HB fingerprint extractor 840 may determine the search HB fingerprint by extracting a unique characteristic included in the HB signal. That is, the HB fingerprint extractor 840 may extract the search HB fingerprint from the HB signal based on the unique characteristic included in the HB signal.

The secondary matcher 850 may determine metadata corresponding to a version of content included in the reference audio signal among the determined plurality of sets of metadata based on the search HB fingerprint. The secondary matcher 850 may search for metadata that matches the search HB fingerprint from the plurality of sets of metadata, which are included in the database 860 and determined at the primary matcher 830. The secondary matcher 850 may conduct a search with respect to a range primarily narrowed by the primary matcher 830 by using the search HB fingerprint as a query. For example, the secondary matcher 850 may determine a reference HB fingerprint having a similarity greater than a preset reference value with the search HB fingerprint among a plurality of reference HB fingerprints corresponding to the plurality of sets of metadata determined at the primary matcher 830, and may determine metadata corresponding to the determined reference HB fingerprint as a search result.

The database 860 may store {metadata, reference LB fingerprint, reference HB fingerprint} corresponding to specific content in a data table as a single set. Content included in the reference audio signal and a version of the content may be identified by searching for metadata stored in the database 860 based on the search LB fingerprint and the search HB fingerprint.

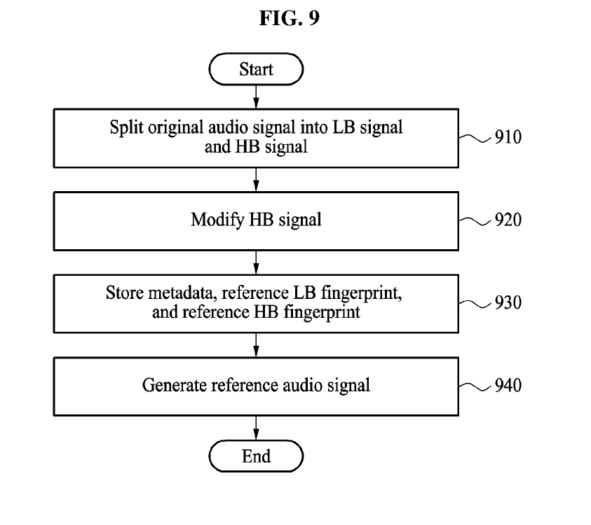

FIG. 9 is a flowchart illustrating an audio signal processing method according to an example embodiment.

The audio signal processing method for registration may be performed at one or more processors included in an audio signal processing apparatus according to an example embodiment.

Referring to FIG. 9, the audio signal processing method may include operation 910 of splitting an original audio signal into an LB signal and an HB signal, operation 920 of modifying the HB signal using an metadata associated to the original audio signal, operation 930 of storing a reference LB fingerprint extracted from the LB signal, a reference HB fingerprint extracted from the modified HB signal, and the associated metadata in database, and operation 940 of generating a reference audio signal synthesized using the LB signal and the modified HB signal.

The description made above with reference to FIGS. 1 through 7 may be applicable to operations 910 through 940 of FIG. 9 and thus, a further description related thereto will be omitted.

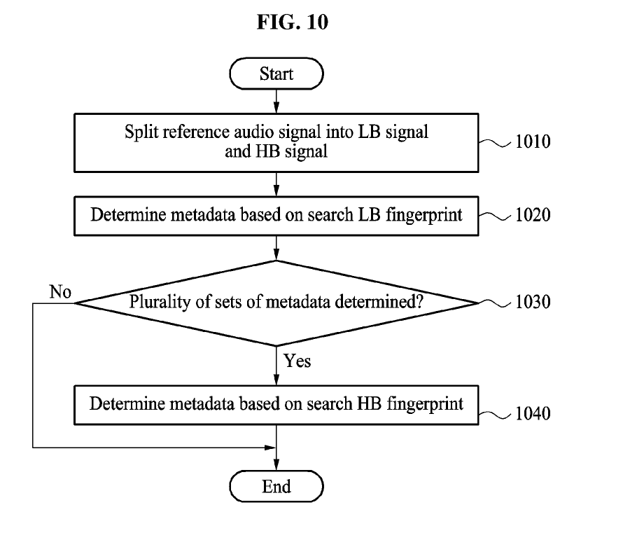

FIG. 10 is a flowchart illustrating a content identifying method according to an example embodiment.

The content identifying method may be performed at one or more processors included in a content identifying apparatus according to an example embodiment.

Referring to FIG. 10, the content identifying method may include operation 1010 of splitting a reference audio signal into an LB signal and an HB signal, operation 1020 of determining metadata corresponding to content included in the reference audio signal based on a search LB fingerprint extracted from the LB signal, operation 1030 of determining whether a plurality of sets of metadata are determined, and operation 1040 of determining metadata corresponding to a version of the content included in the reference audio signal among the determined plurality of sets of metadata based on a search HB fingerprint extracted from the HB signal when the plurality of sets of metadata are determined. When a single set of metadata is determined in operation 1030, the corresponding metadata may be output as information about the content included in the reference audio signal.

According to another example embodiment, the content identifying method may include operations of splitting a unknown reference audio signal into a lower band signal and a higher band signal; extracting a lower band fingerprint from the lower band signal; extracting a higher band fingerprint from the higher band signal; searching reference lower band fingerprint in database using the lower band fingerprint as query to determine candidate set of reference higher band fingerprint and corresponding metadata set; and searching reference higher band fingerprint in the candidate set using the higher band fingerprint as a query to determine a metadata for the matched reference higher band fingerprint.

The description made above with reference to FIGS. 1 through 7 may be applicable to operations 1010 through 1040 of FIG. 10 and thus, a further detailed description related thereto will be omitted.

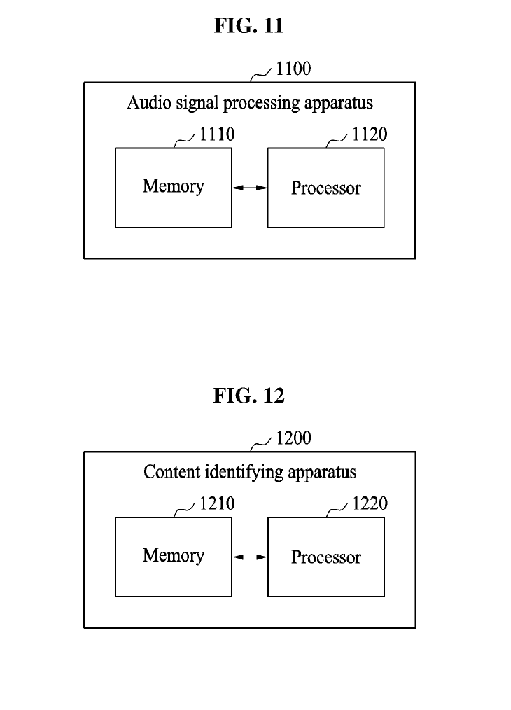

FIG. 11 is a block diagram illustrating an audio signal processing apparatus according to an example embodiment.

Referring to FIG. 11, an audio signal processing apparatus 1100 for registration may include a memory 1110 and a processor 1120.

The memory 1110 may store one or more instructions to be executed at the processor 1120.

The processor 1120 refers to an apparatus that executes the instructions stored in the memory 1110. For example, the processor 1120 may be configured as a single processor or a multi-processor.

The processor 1120 may determine a reference LB fingerprint by extracting a unique characteristic included in an LB signal split from an original audio signal, may modify an HB signal split from the original audio signal using an metadata associated to the original audio signal, may determine a reference HB signal by extracting a unique characteristic included in the modified HB signal, may store the reference LB fingerprint, the reference HB fingerprint, and the associated metadata in database, and may generate a reference audio signal synthesized using the LB signal and the modified HB signal.

The description made above with reference to FIGS. 1 through 7 may be applicable to constituent elements of the audio signal processing 1100 of FIG. 11 and thus, a further detailed description related thereto will be omitted.

FIG. 12 is a block diagram illustrating a content identifying apparatus according to an example embodiment.

Referring to FIG. 12, a content identifying apparatus 1200 may include a memory 1210 and a processor 1220.

The memory 1210 may store one or more instructions to be executed at the processor 1220.

The processor 1220 refers to an apparatus that executes the instructions stored in the memory 1210. For example, the processor 1220 may be configured as a single processor or a multi-processor.

The processor 1220 may split a reference audio signal into an LB signal and an HB signal, may determine metadata corresponding to content included in the reference audio signal based on a search LB fingerprint extracted from the LB signal, and may determine metadata corresponding to a version of the content included in the reference audio signal among a plurality of sets of metadata based on a search HB fingerprint extracted from the HB signal when the plurality of sets of metadata are determined.

The description made above with reference to FIGS. 1 through 8 may be applicable to constituent elements of the audio signal processing 1200 of FIG. 12 and thus, a further detailed description related thereto will be omitted.

The example embodiments described herein may be implemented using hardware components, software components, and/or combination thereof. For example, the apparatuses, the methods, and the components described herein may be configured using one or more general-purpose or special purpose computers, such as, for example, a processor, a controller and an arithmetic logic unit (ALU), a digital signal processor (DSP), a microcomputer, a field programmable array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing an audio signal for registration, the method comprising:
splitting an original audio signal into a lower band signal and a higher band signal;
modifying the higher band signal using an metadata associated to the original audio signal;
storing a reference lower band fingerprint extracted from the lower band signal, a reference higher band fingerprint extracted from the modified higher band signal, and the associated metadata in database; and
generating a reference audio signal synthesized using the lower band signal and the modified higher band signal.

2. The method of claim 1, wherein the modifying of the higher band signal comprises:
transforming the higher band signal to a higher band spectrum;
spectrally modifying the higher band spectrum to generate the modified higher band spectrum using the content ID (identifier) from metadata or arbitrary ID;
inverse-transforming the modified higher band spectrum to the modified higher band signal.

3. The method of claim 2, wherein the spectrally modifying the higher band spectrum comprises:
generating a random spectrum using the content ID or the arbitrary ID as a seed for random number generator;
decomposing the higher band spectrum into magnitude spectrum and phase spectrum;
adding the random spectrum to the magnitude spectrum of the higher band spectrum to generate the modified magnitude spectrum;
combining the modified magnitude spectrum and the phase spectrum to generate the modified higher band spectrum.

4. The method of claim 3, wherein the random spectrum corresponds to an inaudible band of a human that is determined based on an auditory perception characteristic of the human.

5. The method of claim 1, wherein the reference lower band fingerprint includes information capable of identifying content included in the reference audio signal.

6. The method of claim 1, wherein the reference higher band fingerprint includes information capable of identifying content included in the reference audio signal and a version of the content.

7. The method of claim 1, wherein the database stores metadata of content included in an original audio signal and a reference lower band fingerprint and a reference higher band fingerprint extracted from the original audio signal.

8. The method of claim 7, wherein the reference higher band fingerprint is determined by modifying the higher band signal split from the original audio signal and by using a unique characteristic extracted from the modified higher band signal.

9. A method of identifying content, the method comprising:
splitting a unknown reference audio signal into a lower band signal and a higher band signal;
extracting a lower band fingerprint from the lower band signal;
extracting a higher band fingerprint from the higher band signal;
searching reference lower band fingerprint in database using the lower band fingerprint as query to determine candidate set of reference higher band fingerprint and corresponding metadata set; and
searching reference higher band fingerprint in the candidate set using the higher band fingerprint as a query to determine a metadata for the matched reference higher band fingerprint.

10. An apparatus of processing an audio signal for registration, the apparatus comprising:
a memory; and
a processor configured to execute instructions stored on the memory,
wherein the processor is configured to
split an original audio signal into a lower band signal and a higher band signal;
modify the higher band signal using an metadata associated to the original audio signal;
store a reference lower band fingerprint extracted from the lower band signal, a reference higher band fingerprint extracted from the modified higher band signal, and the associated metadata in database; and
generate a reference audio signal synthesized using the lower band signal and the modified higher band signal.

11. The apparatus of claim 10, wherein the processor is further configured to transforming the higher band signal to a higher band spectrum;
spectrally modifying the higher band spectrum to generate the modified higher band spectrum using the content ID from metadata or arbitrary ID;
inverse-transforming the modified higher band spectrum to the modified higher band signal.

12. The apparatus of claim 11, wherein the processor is further configured to generating a random spectrum using the content ID or the arbitrary ID as a seed for random number generator;
decomposing the higher band spectrum into magnitude spectrum and phase spectrum;
adding the random spectrum to the magnitude spectrum of the higher band spectrum to generate the modified magnitude spectrum;
combining the modified magnitude spectrum and the phase spectrum to generate the modified higher band spectrum.

13. The apparatus of claim 12, wherein the random spectrum corresponds to an inaudible band of a human that is determined based on an auditory perception characteristic of the human.

14. The apparatus of claim 10, wherein the reference lower band fingerprint includes information capable of identifying content included in the reference audio signal.

15. The apparatus of claim 10, wherein the reference higher band fingerprint includes unique information capable of identifying content included in the reference audio signal.
